(19) United States
(12) Patent Application Publication
(10) Pub. No.: US 2024/0157603 A1
(43) Pub. Date: May 16, 2024

(54) TILE CUTTER

(71) Applicant: Ishii Tools MFG. Co., Ltd., Miki-shi (JP)

(72) Inventor: Toshikazu ISHII, Miki-shi (JP)

(73) Assignee: Ishii Tools MFG. Co., Ltd., Miki-shi (JP)

(21) Appl. No.: 18/388,081

(22) Filed: Nov. 8, 2023

(30) Foreign Application Priority Data
Nov. 14, 2022 (JP) 2022-181930

(51) Int. Cl. B28D 1/22

(52) U.S. Cl. CPC B28D 1/225

(57) ABSTRACT

A tile cutting apparatus is provided that includes a main body, a lever coupled to the main body, and a pressing member coupled to the lever. The main body includes a base member, a first plate member coupled to the base member, a second plate member coupled to the base member and disposed adjacent to the first plate member, and a projecting member that includes a projecting body. The projecting member is coupled to the first and second plate members such that a force applied to the first and second plate members towards the base member causes the projecting body to move away from the base member and between the first and second plate members. The lever is configured to be rotatable about an axis such that rotating the lever about the axis moves the pressing member towards or away from the base member.

### CROSS-REFERENCE TO RELATED APPLICATIONS

The present application claims priority to and the benefit of Japanese Application No. 2022-181930, filed Nov. 14, 2022 (now JP Patent 7,333,035), the entire contents of which is incorporated herein by reference in its entirety.

### TECHNICAL FIELD

The present application relates generally to a tile cutter. More specifically, the present application provides a tile cutter with improved cutting.

### BACKGROUND

A tile cutter is a specialized tool designed for precision cutting of ceramic, porcelain, or other types of tiles. A tile cutter typically consists of a sturdy base with a movable scoring wheel or blade. The scoring wheel is used to create a shallow groove or cut on a surface of the tile, allowing for a break along the desired cutting line. At least some typical tile cutters, however, may cause transverse cracks in the tiles more often than desired.

### SUMMARY

The present disclosure provides a new and innovative tile cutting apparatus that is configured to reduce a probability of transverse cracks occurring in a tile being cut as a result of induced shear stress in the tile at a cut line in the tile. The tile cutting apparatus includes plate members on which a tile may be placed. A cutting member of the tile cutting apparatus may be used to generate a cutline in the tile where it is desired for the tile to be cut. When the tile is pressed into the plate members, a projecting body of the tile cutting apparatus projects into a side of the tile opposite the side including the cutline. The force of the projecting body pressing into the tile coupled with the opposing force pressing the tile into the plate members generates a shear stress in the tile at the cutline, which improves tile cutting by reducing the probability of transverse cracks occurring during the cut.

In one aspect of the disclosure, a tile cutting apparatus includes a main body, a lever coupled to the main body, and a pressing member coupled to the lever. The main body includes a base member, a first plate member coupled to the base member, a second plate member coupled to the base member and disposed adjacent to the first plate member, and a projecting member that includes a projecting body. The projecting member is coupled to the first and second plate members such that a force applied to the first and second plate members towards the base member causes the projecting body to move away from the base member and between the first and second plate members. The lever is rotatable about an axis such that rotating the lever about the axis moves the pressing member towards or away from the base member.

In an additional aspect of the disclosure, a tile cutting apparatus includes a base member, a first plate member coupled to the base member, a second plate member coupled to the base member and disposed adjacent to the first plate member, a projecting member including a projecting body, and a leverage member. The leverage member includes a first coupling member rotatably coupled to the projecting member and to the first plate member, and a second coupling member rotatably coupled to the projecting member and to the second plate member, such that a force applied to the first and second plate members towards the base member causes the leverage member to move the projecting body away from the base member and between the first and second plate members.

In an additional aspect of the disclosure, a tile cutter includes a main body and a pressing member. The main body includes a base extending in a front-back direction, a first plate member located above the base and extending in the front-back direction, a second plate member located above the base, located on the right of the first plate member, and extending in the front-back direction. The main body also includes a leverage member connected to the base, and a projecting member located between the first plate member and the second plate member and projecting upward. The leverage member includes a first effort portion located below the first plate member, a load portion connected to the projecting member, a first fulcrum portion located between the first effort portion and the load portion and supported by the base. The leverage member also includes a first coupling portion coupling to the first fulcrum portion, the first effort portion, and the first load portion. The pressing member includes a center portion, a left end portion located above the first plate member, and a right end portion located above the second plate member. The left end portion and the right end portion protrude further downward with respect to the center portion. The pressing member, the first plate member and the second plate member are movable downward. The first plate member is connected to the first effort portion. The first coupling portion is rotatable with respect to the first fulcrum portion about a first rotation axis extending in the front-back direction.

In an additional aspect of the disclosure, a tile cutting apparatus includes a base member; a plate member coupled to the base member; and a projecting member. The plate member and the projecting member are each configured such that a force applied to the plate member in a first direction causes the projecting member to move in a second direction opposite the first direction.

Additional features and advantages of the disclosed apparatus are described in, and will be apparent from, the following Detailed Description and the Figures. The features and advantages described herein are not all-inclusive and, in particular, many additional features and advantages will be apparent to one of ordinary skill in the art in view of the figures and description. Moreover, it should be noted that the language used in the specification has been principally selected for readability and instructional purposes, and not to limit the scope of the inventive subject matter.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 illustrates a perspective view of a tile cutter, according to an aspect of the present disclosure.

FIG. 2 illustrates a cross-sectional view of a main body of the tile cutter of FIG. 1, according to an aspect of the present disclosure.

FIG. 3 illustrates a perspective view of a plate member, according to an aspect of the present disclosure.

FIG. 4 illustrates a perspective view of a projecting member, according to an aspect of the present disclosure.

FIG. 5 illustrates a perspective view of a pressing member, according to an aspect of the present disclosure.

FIG. 6 illustrates the cross-sectional view of the main body of FIG. 2 depicting an operation of the tile cutter, according to an aspect of the present disclosure.

FIG. 7 illustrates the cross-sectional view of the main body of FIG. 2 depicting an operation of the tile cutter, according to an aspect of the present disclosure.

FIG. 8 illustrates the perspective view of the tile cutter of FIG. 1 depicting an operation of the tile cutter, according to an aspect of the present disclosure

FIG. 9 illustrates the perspective view of the tile cutter of FIG. 1 depicting a state of use of the tile cutter, according to an aspect of the present disclosure.

FIG. 10 illustrates the cross-sectional view of the main body of FIG. 2 depicting a state of use of the tile cutter, according to an aspect of the present disclosure.

FIG. 11 illustrates a cross-sectional view of the main body of another example of the tile cutter, according to an aspect of the present disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case.

At least some conventional tile cutters may cause transverse cracks in the tile being cut more often than desired. For example, these conventional tile cutters might not generate sufficient shear stress in the tile which allows for the transverse cracks to form. A tile cutting apparatus described herein is configured to reduce the probability of transverse cracks occurring in a tile being cut by inducing improved shear stress in the tile at a cut line in the tile, as compared to conventional tile cutters. The tile cutting apparatus includes plate members on which a tile may be placed. A cutting member of the tile cutting apparatus may be used to generate a cutline in the tile where it is desired for the tile to be cut. When the tile is pressed into the plate members, a projecting body of the tile cutting apparatus projects into a side of the tile opposite the side including the cutline. The force of the projecting body pressing into the tile coupled with the opposing force pressing the tile into the plate members generates a shear stress in the tile at the cutline. The shear stress may improve tile cutting by reducing the probability of transverse cracks occurring during the cut.

Shortcomings mentioned here are only representative and are included to highlight problems identified with respect to existing devices. Aspects of devices described below may address some or all of the shortcomings as well as others known in the art. Aspects of the devices described herein may present other benefits than, and be used in other applications than, those described above.

### Tile Cutter Structure

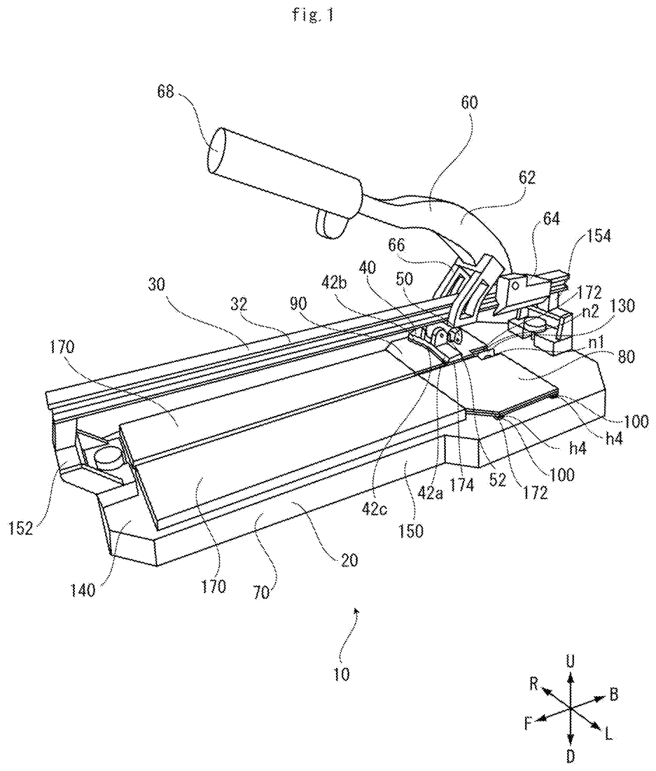

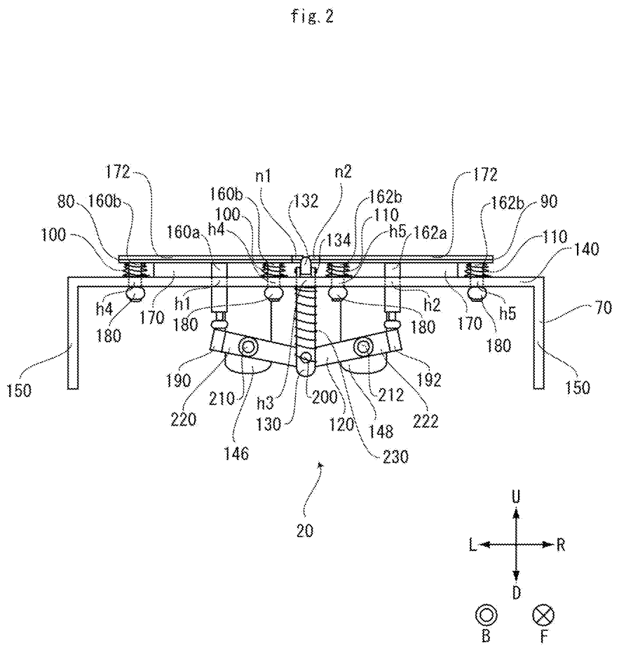

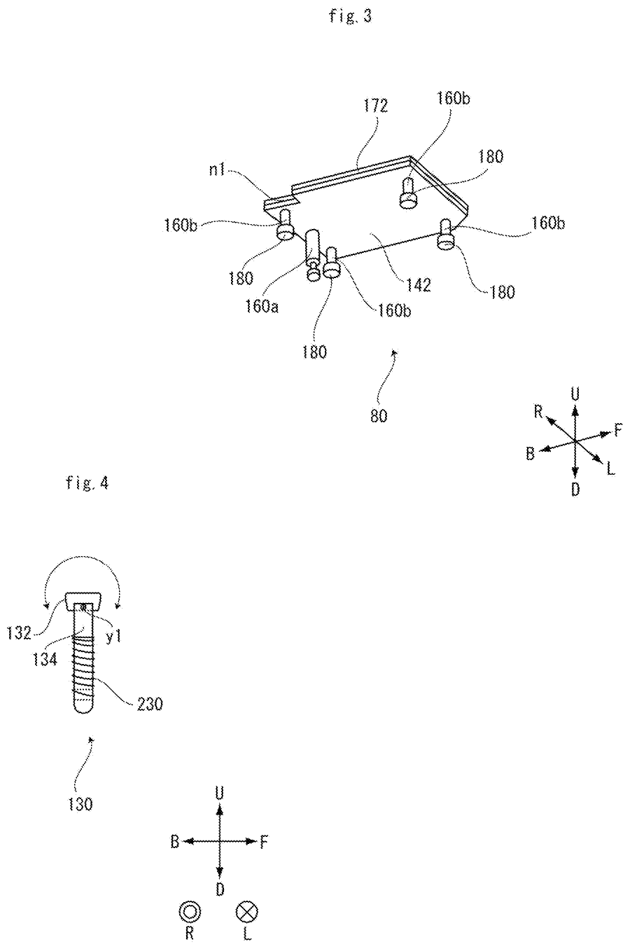

FIGS. 1 to 5 illustrate an example tile cutter 10. Tile cutter 10 includes a main body 20. A guide rail 30 may be coupled to the main body 10. An operating lever 60 may be coupled to the guide rail 30. A pressing member 40 may be coupled to the operating lever 60. A cutting member 50 may be coupled to the operating lever 60. In the illustrated implementation, the tile cutter 10 has a symmetrical structure.

The main body 20 includes a base 70. A first plate member 80 may be coupled to the base 70. A second plate member 90 may be coupled to the base 70. In at least some implementations, the main body 20 includes a plurality of (e.g., four) first resilient members 100. In at least some implementations, the main body 20 includes a plurality of (e.g., four) second resilient members 100. The main body 20 may include a leverage member 120. The main body 20 may include a projecting member 130.

In this specification, directions are defined as provided herein. The base 70 of the main body 20 extends in a front-back direction. A front-back axis, a left-right axis, and an up-down axis are orthogonal to each other. An upward (e.g., “U”) direction, a downward (e.g., “D”) direction, a leftward (e.g., “L”) direction, a rightward (e.g., “R”) direction, a forward (e.g., “F”) direction, and a backward (e.g., “B”) direction are directions defined for the sake of convenience of explanation. Therefore, these directions do not have to be the same as the respective directions of the tile cutter 10 when in use. The upward direction and the downward direction may be interchanged, the leftward direction and rightward direction may be interchanged, and the forward direction and the backward direction may be interchanged.

In this specification, extending in the front-back direction includes extending in a direction parallel to the front-back direction and extending in a direction slightly offset to the front-back direction. Extending in a left-right direction includes extending in a direction parallel to the left-right direction and extending in a direction slightly offset to the left-right direction. Extending in an up-down direction includes extending in a direction parallel to the up-down direction and extending in a direction slightly offset to the up-down direction.

In this specification, each part of a first member is defined as follows unless otherwise specifically noted. A front part of the first member means a front half of the first member. A rear part of the first member means a rear half of the first member. A left part of the first member means a left half of the first member. A right part of the first member means a right half of the first member. An upper part of the first member means an upper half of the first member. A lower part of the first member means a lower half of the first member. A front end of the first member means an end of the first member in a forward direction. A back end of the first member means an end of the first member in the backward direction. A left end of the first member means an end of the first member in the leftward direction. A right end of the first member means an end of the first member in the rightward direction. An upper end of the first member means an end of the first member in the upward direction. A lower end of the first member means an end of the first member in the downward direction. A front-end portion of the first member means the front end and near the front end of the first member. The back-end portion of the first member means the back end and near the back end of the first member. The left end portion of the first member means the left end and near the left end of the first member. The right end portion of the first member means the right end and near the right end of the first member. An upper end portion of the first member means the upper end and near the upper end of the first member. A lower end portion of the first member means a lower end and near the lower end of the first member.

In this specification, a state in which the first member is connected to the second member includes a state in which the first member is directly connected to the second member, and a case where the first member is connected to the second member via a third member. In this specification, the case where the first member is supported by the second member includes a case where the first member is directly supported by the second member, and a case where the first member is supported by the second member via the third member.

Returning to FIGS. 1 to 5, in the illustrated implementation, the base 70 includes a plate member 140 extending in the front-back direction, and a leg portion 150 provided around the plate member 140 and extending downward. Two rubber plates 170 are provided on an upper surface of the plate member 140. The two rubber plates 170 are located in front of the first plate member 80 and the second plate member 90. The plate member 140 is provided with a hole h1, a hole h2, a hole h3, four holes h4, and four holes h5, penetrating therethrough in the up-down direction. The hole h1 is located on a left portion of the plate member 140. The hole h2 is located on a right portion of the plate member 140. The hole h3 is located between the hole h1 and the hole h2. The four holes h4 are located on the left portion of the plate member 140. The four holes h5 are located on the right portion of the plate member 140. The base 70 is made of a metal. More specifically, the plate member 140 and the leg portion 150 may be integrally formed.

The first plate member 80 extends in the front-back direction. The first plate member 80 is located above the base 70. In the illustrated implementation, the first plate member 80 includes a plate member 142 extending in the front-back direction, a rod member 160a and a plurality of (e.g., four) rod members 160b provided on a lower surface of the plate member 142. The rod member 160a and the four rod members 160b extend downward. The rod member 160a is provided at a back-end portion of the plate member 142 and is inserted into the hole h1. The four rod members 160b are provided on a right front-end portion, a right back-end portion, a left front-end portion, and a left back-end portion of the plate member 142, respectively. The four rod members 160b are inserted into the four holes h4, respectively. The four rod members 160b are provided at the lower ends thereof with four nuts 180. The plate member 142 is provided at a right back end thereof with a notch n1. A rubber plate 172 may be provided in the upper surface of the plate member 142. The first plate member 80 may be constructed of a metal.

The second plate member 90 extends in the front-back direction. The second plate member 90 is located above the base 70, and is located on the right of the first plate member 80. In this implementation, the second plate member 90 includes a plate member 144 extending in the front-back direction, a rod member 162a and a plurality of (e.g., four) rod members 162b provided on the lower surface of the plate member 144. The rod member 162a and the four rod members 162b extend downward. The rod member 162a is provided at the back-end portion of the plate member 144 and is inserted into the hole h2. The four rod members 162b are provided on the right front-end portion, the right back-end portion, the left front-end portion, and the left back-end portion of the plate member 144, respectively. The four rod members 162b are inserted into the four holes h5, respectively. The four rod members 162b are provided at the lower ends thereof with four nuts 180. A distance between the plate member 144 and the base 70 is equal to the distance between the plate member 142 and the base 70. In addition, the left back end of the plate member 144 is provided with a notch n2. The rubber plate 172 may be provided in the upper surface of the plate member 144. The second plate member 90 may be constructed of a metal.

The four first resilient members 100 may be connected to the base 70 or the first plate member 80. In this implementation, the four first resilient members 100 are coil springs. The four rod members 160b may be inserted into interiors of the four first resilient members 100, respectively. The four first resilient members 100 bias the first plate member 80 away from the base 70.

The four second resilient members 110 may be connected to the base 70 or the second plate member 90. In this implementation, the four second resilient members 110 are coil springs. The four rod members 162b may be inserted into the interiors of the four second resilient members 110, respectively. The four second resilient members 100 bias the second plate member 80 away from the base 70. The bias away from the base 70 improves workability because the first plate member 80 and the second plate member 90 automatically return to their original positions when force is removed from the first plate member 80 and the second plate member 90 after the completion of the cutting work.

The leverage member 120 may include a first coupling portion 220 and a second coupling portion 222. In this implementation, the leverage member 120 includes a first effort portion 190 and a second effort portion 192. The leverage member 120 a load portion 200, a first fulcrum portion 210, a second fulcrum portion 212. The leverage member 120 may be coupled to the base 70. In this implementation, the leverage member 120 is located below the plate member 140. The leverage member 120 may be made of a metal.

The first effort portion 190 is located below the first plate member 80. In some implementations, the first effort portion 190 may be connected to the first plate member 80. In some implementations, the first plate member 80 is not always connected to the first effort portion 190, but is rather only connected to the first effort portion 190 in a state of the first plate member 80 having been moved downward. In some implementations, the first effort portion 190 is a rectangular parallelepiped member. The upper end of the first effort portion 190 is connected to the lower end of the rod member 160a.

The second effort portion 192 is located below the second plate member 90. In some implementations, the second effort portion 192 may be connected to the second plate member 90. In some implementations, the second plate member 90 is not always connected to the second effort portion 192, but is rather only connected to the second effort portion 192 in a state of the second plate member 80 having been moved downward. In some implementations, the second effort portion 192 is a rectangular parallelepiped member. The upper end of the second effort portion 192 is connected to the lower end of the rod member 162a.

The load portion 200 is connected to the projecting member 130. In this implementation, the load portion 200 is a pin member extending in the front-back direction through a hole in the projecting member 130.

The first fulcrum portion 210 is located between the first effort portion 190 and the load portion 200. The first fulcrum portion 210 is supported by the base 70. In this implementation, the first fulcrum portion 210 is supported by the plate member 140 via a plate member 146 extending from the plate member 140 in the up-down direction. The plate member 146 is provided on the lower surface of the plate member 140. The first fulcrum portion 210 is a pin member extending in the front-back direction through a hole in the first coupling portion 220.

The second fulcrum portion 212 is located between the second effort portion 192 and the load portion 200. The second fulcrum portion 212 is supported by the base 70. In this implementation, the second fulcrum portion 212 is supported by the plate member 140 via a plate member 148 extending from the plate member 140 in the up-down direction. The plate member 148 is provided on the lower surface of the plate member 140. The second fulcrum portion 212 is a pin member extending in the front-back direction through a hole in the second coupling portion 222.

The first coupling portion 220 is coupled to the first fulcrum portion 210, the first effort portion 190, and the load portion 200. In this implementation, the first coupling portion 220 is integrally formed with the first effort portion 190.

The second coupling portion 222 is coupled to the second fulcrum portion 212, the second effort portion 192, and the load portion 200. In this implementation, the second coupling portion 222 is integrally formed with the second effort portion 192.

The projecting member 130 includes a projection body 132 and a projection supporting portion 134. The projecting member 130 is located between the first plate member 80 and the second plate member 90. The projecting member 130 projects further upward with respect to the base 70.

The projection body 132 extends in the front-back direction. In this implementation, the upper end portion of the projection body 132 has a semicircular shape when viewed in the forward direction. In some implementations, the projection body 132 may be made of carbon steel, which improves the durability of the projection body 132.

The projection supporting portion 134 is provided at a lower end portion of the projection body 132 and extends downward. In this implementation, the projection supporting portion 134 is provided with a coil spring 230. The projection supporting portion 134 is inserted into the interiors of a hole h3 and the coil spring 230. The lower end of the projection supporting portion 134 is connected to the load portion 200. The projection supporting portion 134 is connected to the projection body 132. The coil spring 230 is connected to the plate member 140 and the load portion 200. The coil spring 230 biases the load portion 200 away from the plate member 140.

The guide rail 30 extends in the front-back direction. In this implementation, the guide rail 30 is located above the main body 20. For example, the guide rail 30 includes a rail portion 32 extending in the front-back direction, a leg portion 152 provided at the front end of the rail portion 32 and extending downward, and a leg portion 154 provided at the back end of the rail portion 32 and extending downward. The leg portion 152 is supported at the front-end portion of the base 70. The leg portion 154 is supported at the back-end portion of the base 70.

The pressing member 40 extends in the left-right direction. The pressing member 40 is connected to the guide rail 30 via the operating lever 60. In this implementation, the pressing member 40 includes a left end portion 42a, a right end portion 42b, and a center portion 42c. The left end portion 42a and the right end portion 42b project further downward with respect to the center portion 42c. The left end portion 42a is located above the first plate member 80. The right end portion 42b is located above the second plate member 90. The distance between the left end portion 42a and the center portion 42c is equal to the distance between the right end portion 42b and the center portion 42c. The distance between the left end portion 42a and the first plate member 80 is equal to the distance between the right end portion 42b and the second plate member 90. A rubber plate 174 may be provided on the lower surface of the pressing member 40.

The cutting member 50 is connected to the guide rail 30 via the operating lever 60. The cutting member 50 is located above the projecting member 130 during operation of the tile cutter 10. In other instances, the cutting member 50 In this implementation, the cutting member 50 is connected to the operating lever 60. The cutting member 50 may be located on the back side of the pressing member 40. The cutting member 50 may have a circular rotating blade 52.

The operating lever 60 is connected to the guide rail 30, the pressing member 40, and the cutting member 50. In this implementation, the operating lever 60 includes a lever body 62 extending in a backward and downward direction. The operating lever 60 may include a sliding portion 64 provided at the back end of the lever body 62 and connected to the guide rail 30. The operating lever 60 may include an extension portion 66 provided on the lever body 62 and extending forward and downward. The pressing member 40 and the cutting member 50 may be connected to the extension portion 66. For example, the extension portion 66 may be a cylindrical member and the rail portion 32 may be inserted into the extension portion 66. A grip 68 may be provided at the front end of the lever body 62.

### Tile Cutter Operation

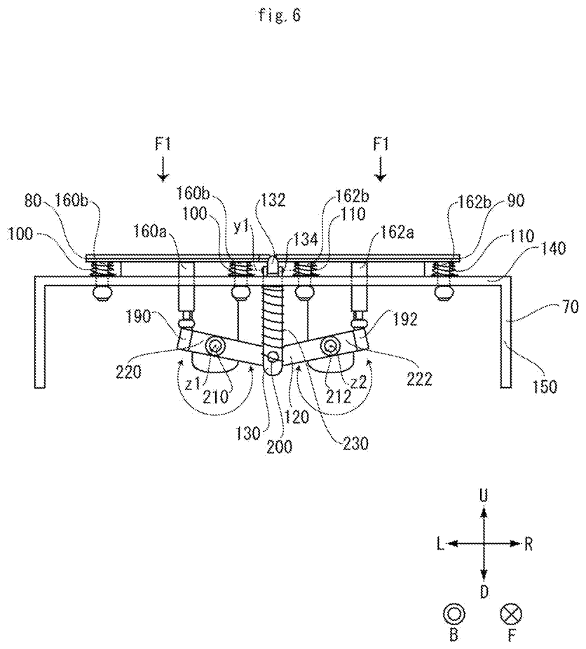

Operations of the tile cutter 10 will now be described. FIGS. 6 to 8 are explanatory drawings illustrating the operation of the tile cutter 10.

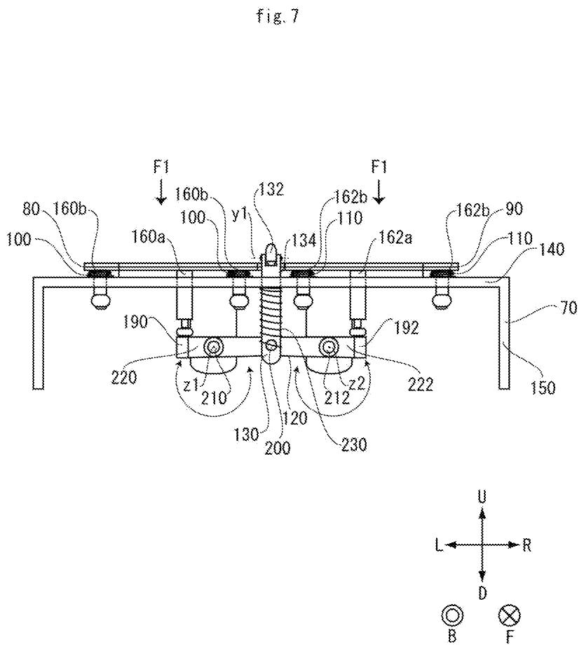

As illustrated in FIG. 6 and FIG. 7, the first coupling portion 220 is rotatable with respect to the first fulcrum portion 210 about a first rotation axis z1. The first rotation axis z1 extends in the front-back direction.

The second coupling portion 222 is rotatable with respect to the second fulcrum portion 212 about a second rotation axis z2. The second rotation axis z2 extends in the front-back direction. The first plate member 80 is located above the first effort portion 190, and is movable downward.

The leverage member 120 is interlocked with the first plate member 80. When a force F1 in the downward direction is applied to the first plate member 80, the first plate member 80 moves downward. The first effort portion 190 is then pushed downward by the rod member 160a and moves downward. Consequently, the first coupling portion 220 rotates counterclockwise when viewed in the forward direction, and the load portion 200 and the projecting member 130 move upward. The projecting member 130 also projects further upward with respect to the first plate member 80. When the force F1 is removed, the first plate member 80, the leverage member 120, and the projecting member 130 are restored to their original positions by a restoring force of the first resilient member 100 and the coil spring 230.

The second plate member 90 is located above the second effort portion 192, and is movable downward. The leverage member 120 is interlocked with the second plate member 90. When a force F1 in the downward direction is applied to the second plate member 90, the second plate member 90 moves downward. The second effort portion 192 is then pushed downward by the rod member 162a and moves downward. Consequently, the second coupling portion 222 rotates clockwise when viewed in the forward direction, and the load portion 200 and the projecting member 130 move upward. The projecting member 130 also projects further upward with respect to the second plate member 90. When the force F1 is removed, the second plate member 90, the leverage member 120, and the projecting member 130 are restored to their original positions by a restoring force of the second resilient member 110 and the coil spring 230.

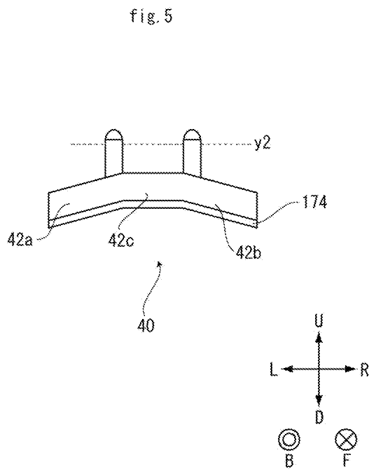

As illustrated in FIGS. 4 and 6, the projection body 132 is rotatable with respect to the projection supporting portion 134 about a third rotation axis y1. The third rotation axis y1 extends in the left-right direction.

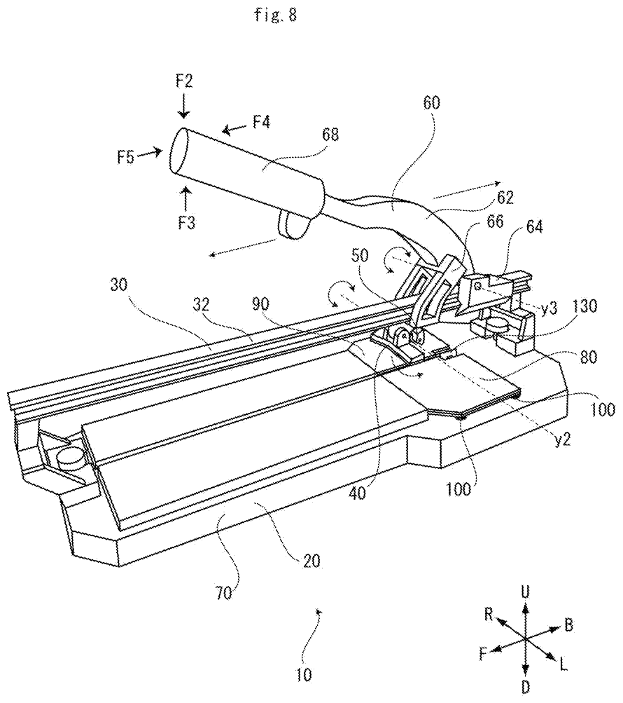

As illustrated in FIGS. 5 and 8, the pressing member 40 is rotatable with respect to the operating lever 60 about a fourth rotation axis y2. The fourth rotation axis y2 extends in the left-right direction.

The pressing member 40 is movable in the up-down direction. For instance, the lever body 62 and the extension portion 66 are rotatable with respect to the sliding portion 64 about a fifth rotation axis y3 so that the pressing member 40 is movable downward. The fifth rotation axis y3 extends in the left-right direction. When a force F2 in the downward direction is applied to the front end of the lever body 62, the lever body 62 and the extension portion 66 rotate counterclockwise when viewed toward the right about the fifth rotation axis y3. Consequently, the pressing member 40 connected to the extension portion 66 moves backward and downward, and comes into contact with the first plate member 80 and the second plate member 90. In some implementations, the pressing member 40 may solely move downward instead of backward and downward. Or, the pressing member 40 may move forward and downward instead of backward and downward. Subsequently, when a force F3 in the upward direction is applied to the front end of the lever body 62, the lever body 62 and the extension portion 66 rotate clockwise when viewed toward the right about the fifth rotation axis y3. Consequently, the pressing member 40 moves forward and upward and returns to the original position.

The pressing member 40 is movable in the front-back direction. For instance, the sliding portion 64 is slidable in the front-back direction along the rail portion 32 so that the pressing member 40 is movable in the front-back direction. When a force F4 in the forward direction is applied to the operating lever 60, the operating lever 60 and the pressing member 40 connected to the operating lever 60 move forward. When a force F5 in the backward direction is applied to the operating lever 60, the operating lever 60 and the pressing member 40 connected to the operating lever 60 move backward.

In some implementations, the pressing member 40 might not be movable in the backward direction, or might not be movable in the forward direction.

The cutting member 50 connected to the operating lever 60 is movable in the up-down direction and the front-back direction in the same manner as the pressing member 40.

The operating lever 60 operates the movements of the pressing member 40 and the cutting member 50 as described above.

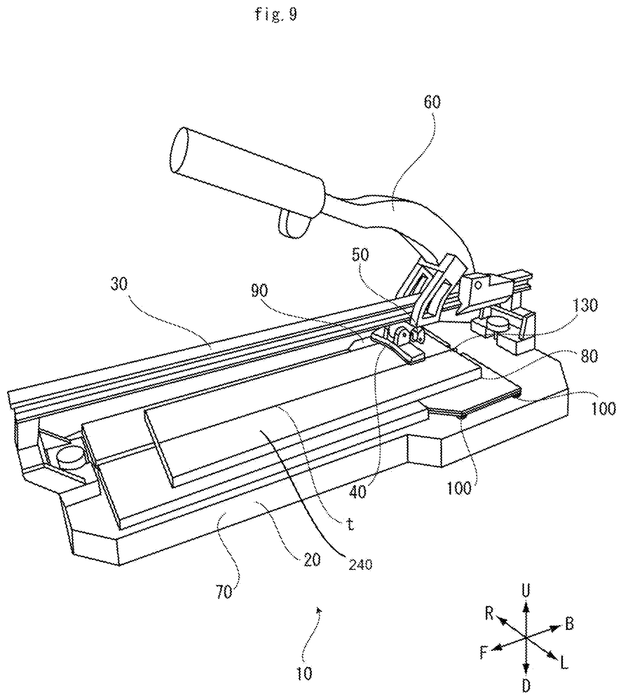

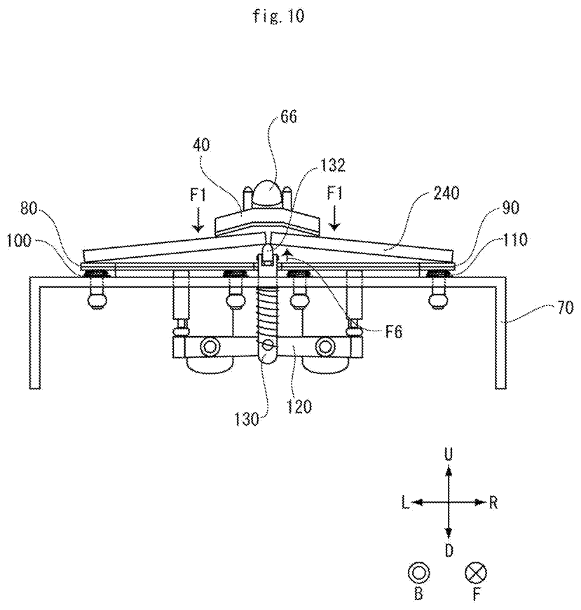

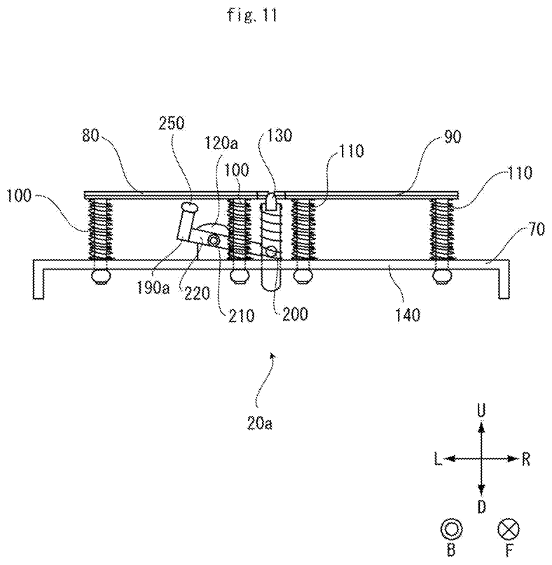

FIGS. 9 and 10 are explanatory drawings illustrating the tile cutter 10 being used with a tile 240. As illustrated in FIG. 9, a user firstly places a tile 240 on the first plate member 80 and the second plate member 90. In various instances, the tile 240 may be a porcelain tile, a stoneware tile, or a ceramic tile. Then, the operating lever 60 may be operated to move the cutting member 50 downward until it comes into contact with the upper surface of the tile 240. The operating lever 60 may then be moved further in the forward direction. This movement of the operating lever 60 allows formation of a linear cutline t passing between the first plate member 80 and the second plate member 90 on the upper surface of the tile 240. The cutline t is located above the projecting member 130, and extends in the front-back direction. When the tile 240 is cut, the stress concentrates along the cutline t, which reduces the probability of occurrence of transverse cracks in the tile 240 during cutting.

Then, the user operates the operating lever 60 to move the pressing member 40 downward until it comes into contact with the upper surface of the tile 240. The pressing member 40 may rotate with respect to the extension portion 66, and the lower surface of the pressing member 40 comes into contact with the upper surface of the tile 240. The left end portion 42a and the right end portion 42b are in contact with the tile 240, while the center portion 42c is not in contact with the upper surface of the tile 240. Subsequently, when the pressing member 40 is moved further downward, the first plate member 80 and the second plate member 90 are pushed downward by the pressing member 40 via the tile 240, whereby the leverage member 120 is operated. Consequently, the projecting member 130 moves upward.

As illustrated in FIG. 10, a force F1 is applied to the tile 240 in the downward direction by the left end portion 42a and the right end portion 42b and, simultaneously, a force F6 is applied to the tile 240 in the upward direction by the projecting member 130. The force F1 and the force F6 create shear stress in the tile 240 at the cutline t, which improves the cutting of the tile 240. Forcing the pressing member 40 downward into the tile 240, and thereby forcing the first and second plate members 80 and 90 downward, causes the projecting member 130 to move upward according to an amount of downward movement of the pressing member 40, which thereby makes the shear stress generated in the tile 240 adjustable. Additionally, the tile cutter 10 is structured such that equal force is applied to both sides of the tile 240. Each of these features may reduce the probability of transverse cracks occurring in the tile 240 during cutting.

The force F1 and the force F6 are generated at the front-end portion of the tile 240. Therefore, the back-end portion of the tile 240, which is not under force, will lift upward, causing tile 240 to tilt. On the other hand, the projection body 132 is in contact with the lower surface of the tile 240. As described above, the projection body 132 is rotatable with respect to the projection supporting portion 134 about the third rotation axis y1. As such, the projection body 132 can rotate with the tilt of the tile 240 due to the reaction force received from the tile 240. Consequently, the contact between the projection supporting portion 134 and the tile 240 is maintained, thereby further reducing the probability of occurrence of transverse cracks in the tile 240 during cutting.

FIG. 11 illustrates a second example of the provided tile cutter. Tile cutter 10a, as illustrated in FIG. 11, is different from the tile cutter 10 in that the main body 20a of the tile cutter 10a does not includes the rod member 160a, the rod 162a, the second effort portion 192, the second fulcrum portion 212 and the second coupling portion 222. Additionally, the main body 20a of tile cutter 10a is not provided with the hole h1 and the hole h2.

In the illustrated second example, the leverage member 120a of the tile cutter 10a is located above the plate member 140. In addition, a first effort portion 190a of the leverage member 120a includes a projecting portion 250 at the upper end thereof. The projecting portion 250 projects upward. The first plate member 80 is not connected to the first effort portion 190a in the state illustrated in FIG. 11, but is connected to the first effort portion 190a as the first plate member 80 moves downward. For instance, the lower surface of the plate member 140 is connected to the upper end of the projecting portion 250. The tile cutter 10a as described above may achieve the same advantageous effects as the tile cutter 10.

In one or more aspects, the tile cutter 10 or tile cutter 10a may include additional aspects, such as any single aspect or any combination of aspects described below.

In a first aspect, a tile cutting apparatus includes a main body, a lever coupled to the main body, and a pressing member coupled to the lever. The main body includes a base member, a first plate member coupled to the base member, a second plate member coupled to the base member and disposed adjacent to the first plate member, and a projecting member that includes a projecting body. The projecting member is coupled to the first and second plate members such that a force applied to the first and second plate members towards the base member causes the projecting body to move away from the base member and between the first and second plate members. The lever is rotatable about an axis such that rotating the lever about the axis moves the pressing member towards or away from the base member.

In a second aspect, in combination with the first aspect, the main body further includes a leverage member coupled to the first and second plate members and to the projecting member such that a force applied to the first and second plate members towards the base member causes the leverage member to move the projecting body away from the base member and between the first and second plate members.

In a third aspect, in combination with the second aspect, the leverage member includes a first coupling member rotatably coupled to the projecting member and to the first plate member, and a second coupling member rotatably coupled to the projecting member and to the second plate member.

In a fourth aspect, in combination with the third aspect, the main body further includes a third plate member extending from the base member and a fourth plate member extending from the base member. The first coupling member is rotatably coupled to the third plate member and the second coupling member is rotatably coupled to the fourth plate member.

In a fifth aspect, in combination with the fourth aspect, the first and second coupling members each rotate relative to the projecting member about a second axis, the first coupling member rotates relative to the third plate member about a third axis, the second coupling member rotates relative to the fourth plate member about a fourth axis, and the second axis, the third axis, and the fourth axis are all parallel to one another.

In a sixth aspect, in combination with the second aspect, the main body further includes a first rod extending from the first plate member and coupled to the leverage member, and a second rod extending from the second plate member and coupled to the leverage member.

In a seventh aspect, in combination with one or more of the first aspect through the sixth aspect, the apparatus further includes a first plurality of resilient members disposed between the first plate member and the base member, and a second plurality of resilient members disposed between the second plate member and the base member.

In an eighth aspect, in combination with one or more of the first aspect through the seventh aspect, the apparatus further includes a resilient member disposed around a portion of the projecting member.

In a ninth aspect, in combination with one or more of the first aspect through the eighth aspect, the pressing member includes: a first end portion disposed on a first side of the main body that includes the first plate member, a second end portion disposed on a second side of the main body that includes the second plate member, and a central portion disposed between the first and second end portions. A first distance between the first end portion and the first plate member is less than a second distance between the central portion and the first end portion.

In a tenth aspect, in combination with the ninth aspect, a third distance between the second end portion and the second plate member is equal to the first distance.

In an eleventh aspect, in combination with one or more of the first aspect through the tenth aspect, the projecting member includes a support portion coupled to the projecting body, and the projecting body is rotatable relative to the support portion.

In a twelfth aspect, in combination with one or more of the first aspect through the eleventh aspect, the apparatus further includes a guide rail. The lever is coupled to the guide rail such that the lever can be translated along a length of the guide rail.

In a thirteenth aspect, in combination with one or more of the first aspect through the twelfth aspect, the apparatus further includes a cutting member coupled to the lever.

In a fourteenth aspect, a tile cutting apparatus includes a base member, a first plate member coupled to the base member, a second plate member coupled to the base member and disposed adjacent to the first plate member, a projecting member including a projecting body, and a leverage member. The leverage member includes a first coupling member rotatably coupled to the projecting member and to the first plate member, and a second coupling member rotatably coupled to the projecting member and to the second plate member, such that a force applied to the first and second plate members towards the base member causes the leverage member to move the projecting body away from the base member and between the first and second plate members.

In a fifteenth aspect, in combination with the fourteenth aspect, the apparatus further includes a third plate member extending from the base member, and a fourth plate member extending from the base member. The first coupling member is rotatably coupled to the third plate member and the second coupling member is rotatably coupled to the fourth plate member.

In a sixteenth aspect, in combination with one or more of the fourteenth aspect through the fifteenth aspect, the apparatus further includes a first rod extending from the first plate member and coupled to the first coupling member, and a second rod extending from the second plate member and coupled to the second coupling member.

In a seventeenth aspect, in combination with one or more of the fourteenth aspect through the sixteenth aspect, the projecting member includes a support portion coupled to the projecting body. The support portion is rotatably coupled to the first and second coupling members, and the projecting body is rotatably coupled to the support portion.

In an eighteenth aspect, in combination with one or more of the fourteenth aspect through the seventeenth aspect, the leverage member is disposed on a first side of the first and second plate members, and the tile cutting apparatus further includes a guide rail coupled to the base member and disposed on a second side of the first and second plate members that is opposite the first side.

In a nineteenth aspect, in combination with the eighteenth aspect, the apparatus further includes a lever coupled to the guide rail such that the lever can be translated along a length of the guide rail.

In a twentieth aspect, in combination with one or more of the fourteenth aspect through the nineteenth aspect, pressing the first and second plate members towards the base member causes the leverage member to move the projecting body away from the base member and between the first and second plate members such that when a first force is applied to a tile positioned on the first and second plate members, the projecting body applies a second force to the tile.

In a twenty-first aspect, in combination with one or more of the first aspect through the twentieth aspect, the apparatus further includes a resilient member configured to bias a pivot point about which the first and second coupling members rotate relative to the projecting member away from the base member.

In a twenty-second aspect, in combination with one or more of the first aspect through the twenty-first aspect, the apparatus further includes a first plurality of resilient members configured to bias the first plate member away from the base member, and a second plurality of resilient members configured to bias the second plate member away from the base member.

In a twenty-third aspect, a tile cutting apparatus includes a main body and a pressing member. The main body includes a base extending in a front-back direction, a first plate member located above the base and extending in the front-back direction, a second plate member located above the base, located on the right of the first plate member, and extending in the front-back direction. The main body also includes a leverage member connected to the base, and a projecting member located between the first plate member and the second plate member and projecting upward. The leverage member includes a first effort portion located below the first plate member, a load portion connected to the projecting member, a first fulcrum portion located between the first effort portion and the load portion and supported by the base. The leverage member also includes a first coupling portion coupling to the first fulcrum portion, the first effort portion, and the first load portion. The pressing member includes a center portion, a left end portion located above the first plate member, and a right end portion located above the second plate member. The left end portion and the right end portion protrude further downward with respect to the center portion. The pressing member, the first plate member and the second plate member are movable downward. The first plate member is connected to the first effort portion. The first coupling portion is rotatable with respect to the first fulcrum portion about a first rotation axis extending in the front-back direction.

In a twenty-fourth aspect, in combination with the twenty-third aspect, the leverage member further includes: a second effort portion located below the second plate member; a second fulcrum portion located between the second effort portion and the load portion and supported by the base, and a second coupling portion coupling to the second fulcrum portion, the second effort portion, and the load portion, the second plate member is connected to the second effort portion, and the second coupling portion is rotatable with respect to the second fulcrum portion about a second rotation axis extending in the front-back direction.

In a twenty-fifth aspect, in combination with the twenty-third aspect or the twenty-fourth aspect, the main body further includes a first resilient member and a second resilient member, the first resilient member is connected to the base and the first plate member, and the second resilient member is connected to the base and the second plate member.

In a twenty-sixth aspect, in combination with the twenty-third aspect or the twenty-fourth aspect, the projecting member includes: a projection body extending in the front-back direction; and a projection supporting portion extending downward, and the projection body is rotatable with respect to the projection supporting portion about a third rotation axis extending in a left-right direction.

In a twenty-seventh aspect, in combination with the twenty-sixth aspect, the projection body is made of carbon steel.

In a twenty-eighth aspect, in combination with the twenty-third aspect or the twenty-fourth aspect, the apparatus further including an operating lever, in which the operating lever operates a movement of the pressing member.

In a twenty-ninth aspect, in combination with the twenty-eighth aspect, the apparatus further including a guide rail and a cutting member, the pressing member and the cutting member are connected to the guide rail, the guide rail extends in the front-back direction, the cutting member is located above the projecting member, the cutting member is movable downward, the cutting member is movable in the front-back direction, and the operating lever operates the movement of the cutting member.

In a thirtieth aspect, a tile cutting apparatus includes a base member; a plate member coupled to the base member; and a projecting member. The plate member and the projecting member are each configured such that a force applied to the plate member in a first direction causes the projecting member to move in a second direction opposite the first direction.

Herein, “or” is inclusive and not exclusive, unless expressly indicated otherwise or indicated otherwise by context. Therefore, herein, “A or B” means “A, B, or both,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context.

The above specification provides a complete description of the structure and use of illustrative embodiments of this disclosure. Although certain embodiments have been described above with a certain degree of particularity, or with reference to one or more individual embodiments, the scope of this disclosure encompasses all changes, substitutions, variations, alterations, and modifications to the example embodiments described or illustrated herein that a person having ordinary skill in the art would comprehend. The scope of this disclosure is not limited to the example embodiments described or illustrated herein. Moreover, although this disclosure describes and illustrates respective embodiments herein as including particular components, elements, feature, functions, operations, or steps, any of these embodiments may include any combination or permutation of any of the components, elements, features, functions, operations, or steps described or illustrated anywhere herein that a person having ordinary skill in the art would comprehend. Furthermore, reference in the appended claims to an apparatus or system or a component of an apparatus or system being adapted to, arranged to, capable of, configured to, enabled to, operable to, or operative to perform a particular function encompasses that apparatus, system, component, whether or not it or that particular function is activated, turned on, or unlocked, as long as that apparatus, system, or component is so adapted, arranged, capable, configured, enabled, operable, or operative. Additionally, although this disclosure describes or illustrates particular embodiments as providing particular advantages, particular embodiments may provide none, some, or all of these advantages.

### REFERENCE SIGN LIST

10 tile cutter
10a tile cutter
20 main body
20a main body
30 guide rail
32 rail portion
40 pressing member
42a left end portion
42b right end portion
42c center portion
44 extension portion
46 sliding portion
50 cutting member
52 rotating blade
60 operating lever
62 lever body
64 sliding portion
66 extension portion
68 grip
70 base
80 first plate member
90 second plate member
100 first resilient member
110 second resilient member
120 leverage member
120a leverage member
130 projecting member
132 projection body
134 projection supporting portion
140 plate member
142 plate member
144 plate member
146 plate member
148 plate member
150 leg portion
152 leg portion
154 leg portion
160a rod member
160b rod member
162a rod member
162b rod member
170 rubber plate
172 rubber plate
180 nut
190 first effort portion
190a first effort portion
192 second effort portion
200 load portion
210 first fulcrum portion
212 second fulcrum portion
220 first coupling portion
222 second coupling portion
230 coil spring
240 tile
250 projecting portion
h1 hole
h2 hole
h3 hole
h4 hole
h5 hole
n1 notch
n2 notch
t cutline
y1 third rotation axis
y2 fourth rotation axis
y3 fifth rotation axis
z1 first rotation axis
z2 second rotation axis
F1 force
F2 force
F3 force
F4 force
F5 force
F6 force

1. A tile cutting apparatus comprising:
a main body including:
a base member;
a first plate member coupled to the base member;
a second plate member coupled to the base member and disposed adjacent to the first plate member; and
a projecting member including a projecting body, wherein the projecting member is coupled to the first and second plate members such that a force applied to the first and second plate members towards the base member causes the projecting body to move away from the base member and between the first and second plate members;
a lever coupled to the main body; and
a pressing member coupled to the lever, the lever configured to be rotatable about an axis such that rotating the lever about the axis moves the pressing member towards or away from the base member.

2. The tile cutting apparatus of claim 1, wherein the main body further includes a leverage member coupled to the first and second plate members and to the projecting member such that a force applied to the first and second plate members towards the base member causes the leverage member to move the projecting body away from the base member and between the first and second plate members.

3. The tile cutting apparatus of claim 2, wherein the leverage member includes:
a first coupling member rotatably coupled to the projecting member and to the first plate member; and
a second coupling member rotatably coupled to the projecting member and to the second plate member.

4. The tile cutting apparatus of claim 3, wherein the main body further includes a third plate member extending from the base member and a fourth plate member extending from the base member, wherein the first coupling member is rotatably coupled to the third plate member and the second coupling member is rotatably coupled to the fourth plate member.

5. The tile cutting apparatus of claim 4, wherein the first and second coupling members each rotate relative to the projecting member about a second axis, wherein the first coupling member rotates relative to the third plate member about a third axis, wherein the second coupling member rotates relative to the fourth plate member about a fourth axis, and wherein the second axis, the third axis, and the fourth axis are all parallel to one another.

6. The tile cutting apparatus of claim 2, wherein the main body further includes:
a first rod extending from the first plate member and coupled to the leverage member; and
a second rod extending from the second plate member and coupled to the leverage member.

7. The tile cutting apparatus of claim 1, further comprising:
a first plurality of resilient members disposed between the first plate member and the base member; and
a second plurality of resilient members disposed between the second plate member and the base member.

8. The tile cutting apparatus of claim 1, further comprising:
a resilient member disposed around a portion of the projecting member.

9. The tile cutting apparatus of claim 1, wherein the pressing member includes:
a first end portion disposed on a first side of the main body that includes the first plate member;
a second end portion disposed on a second side of the main body that includes the second plate member; and
a central portion disposed between the first and second end portions, wherein a first distance between the first end portion and the first plate member is less than a second distance between the central portion and the first end portion.

10. The tile cutting apparatus of claim 9, wherein a third distance between the second end portion and the second plate member is equal to the first distance.

11. The tile cutting apparatus of claim 1, wherein:
the projecting member includes a support portion coupled to the projecting body, and
the projecting body is rotatable relative to the support portion.

12. The tile cutting apparatus of claim 1, further comprising:
a guide rail, and
wherein the lever is coupled to the guide rail such that the lever can be translated along a length of the guide rail.

13. The tile cutting apparatus of claim 1, further comprising:
a cutting member coupled to the lever.

14. A tile cutting apparatus comprising:
a base member;
a first plate member coupled to the base member;
a second plate member coupled to the base member and disposed adjacent to the first plate member;
a projecting member including a projecting body; and
a leverage member including a first coupling member rotatably coupled to the projecting member and to the first plate member, and a second coupling member rotatably coupled to the projecting member and to the second plate member, such that a force applied to the first and second plate members towards the base member causes the leverage member to move the projecting body away from the base member and between the first and second plate members.

15. The tile cutting apparatus of claim 14, further comprising:
a third plate member extending from the base member; and
a fourth plate member extending from the base member, and
wherein the first coupling member is configured to be rotatably coupled to the third plate member and the second coupling member is rotatably coupled to the fourth plate member.

16. The tile cutting apparatus of claim 14, further comprising:
a first rod extending from the first plate member and coupled to the first coupling member; and
a second rod extending from the second plate member and coupled to the second coupling member.

17. The tile cutting apparatus of claim 14, wherein:
the projecting member includes a support portion coupled to the projecting body,
the support portion is rotatably coupled to the first and second coupling members, and
the projecting body is rotatably coupled to the support portion.

18. The tile cutting apparatus of claim 14, wherein:
the leverage member is disposed on a first side of the first and second plate members, and
the tile cutting apparatus further comprises:
a guide rail coupled to the base member and disposed on a second side of the first and second plate members that is opposite the first side.

19. The tile cutting apparatus of claim 18, further comprising:
a lever coupled to the guide rail such that the lever can be translated along a length of the guide rail.

20. A tile cutting apparatus comprising:
a base member;
a plate member coupled to the base member; and
a projecting member,
wherein the plate member and the projecting member are each configured such that a force applied to the plate member in a first direction causes the projecting member to move in a second direction opposite the first direction.
